(19) United States
(12) Patent Application Publication
(10) Pub. No.: US 2007/0162950 A1
(43) Pub. Date: Jul. 12, 2007

(54) Receiving and display system, receiving apparatus and display terminal

(75) Inventor: Fuminori Homma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation.

(21) Appl. No.: 11/646,437

(22) Filed: Dec. 28, 2006

(30) Foreign Application Priority Data
Jan. 6, 2006 (JP) P2006-001248

(51) Int. Cl. H04N 7/16; H04N 7/173; H04N 7/20

(52) U.S. Cl. 725/134; 725/68; 725/131; 725/139; 725/142

(57) ABSTRACT

Disclosed herein is a receiving and display system including, a receiving apparatus, and a display terminal, wherein, the receiving apparatus receiving data from outside and the display terminal displaying information by receiving data from the receiving apparatus, wherein, upon receipt of an upgraded program from outside, the receiving apparatus checks to determine whether the upgraded program is destined for the receiving apparatus or for the display terminal, the receiving apparatus further writing the upgraded program to a storage device of the receiving apparatus if the upgraded program is found to be destined for the receiving apparatus, the receiving apparatus further transferring the upgraded program to the display terminal if the upgraded program is found to be destined for the display terminal, and wherein the display terminal writes the upgraded program transferred from the receiving apparatus to a storage device of the display terminal.

### CROSS REFERENCES TO RELATED APPLICATIONS

The present invention contains subject matter related to Japanese Patent Application JP 2006-001248 filed with the Japanese Patent Office on Jan. 6, 2006, the entire contents of which being incorporated herein by reference.

### BACKGROUND OF THE INVENTION

1. Field of the Invention

The present invention relates to a receiving and display system such as a wireless TV (television) system made up of a receiving apparatus and a display terminal, as well as to a receiving apparatus and a display terminal constituting that receiving and display system.

2. Description of the Related Art

TV broadcasts have gone digital, including CS (communication satellite), BS (broadcasting satellite) and terrestrial digital broadcasts. This trend has entailed implementation of a new scheme. Under this scheme, the broadcasting side broadcasts not only video and audio data but also programs, and the receiving side receives the broadcast programs and records the received programs to a storage device of a receiver for use by components of the receiving side.

Illustratively, one patent document (Japanese Patent Laid-open NO. Hei 8-195952) discloses a scheme under which the broadcasting side transmits an upgraded program diverging from the basic program held in digital TV sets (decoders). The transmitted program is received by and stored into the receiver for upgrades.

There also exists a type of receiving and display system which is made up of a base station (receiving apparatus) and a display terminal. The base station incorporates a TV tuner for receiving TV broadcasts. The display terminal establishes a wireless LAN (local area network) with the base station illustratively pursuant to the IEEE 802.11a standard, receives data from the base apparatus over the LAN, and displays video and other information on a display device.

Another patent document (Japanese Patent Laid-open No. 2002-163112) discloses one such receiving and displays system constituted by a base station and a plurality of display terminals designed for upgrades. With this system, an upgraded program for the base station and one for the display terminals are placed onto a detachable storage medium such as a memory card. The upgrades-carrying medium is loaded into one of the display terminals. In turn, the medium-loaded display terminal replaces its existing program with the upgraded program, and forwards the upgraded program bound for the base station and that for the display terminal to the base station. Upon receipt of the forwarded programs, the base station replaces its current program with the upgraded program and sends the display terminal-destined upgraded program to the other display terminals. The other display terminals in turn replace their current programs with the terminal-bound upgraded program.

### SUMMARY OF THE INVENTION

When updating its component base station (receiving apparatus) and display terminals, the receiving and display system disclosed by the second patent document above needs to have the upgraded programs recorded on a storage medium and getting the medium loaded into one of its display terminals. From the medium-loaded display terminal, the upgraded programs are forwarded to the other system components for upgrades. With this system, each user needs to obtain the storage medium carrying the upgraded programs, apart from reception of TV broadcasts through the base station. The provider of programs needs to distribute the storage media containing the upgraded programs to the users involved. The procedure for upgrading is thus inconvenient and tiresome for both the users and the program provider.

Hence the need for a receiving and display system made up of a base station and a display terminal of which the programs may be upgraded using broadcast programs, as described by the first patent document above.

To implement such a broadcast-upgradeable system had to solve the following problem: the system as a whole would become inordinately complex and costly if the display terminal were to be supplemented with a TV tuner in addition to the one for the base station for receiving TV broadcasts.

The present invention has been made in view of the above circumstances and provides a receiving and display system made up of a receiving apparatus and a display terminal with no ability to directly receive data from outside of the system, the receiving apparatus being capable of receiving upgraded program sent from outside of the system so that existing programs in the receiving apparatus and in the display terminal may be replaced by the upgraded programs received.

In carrying out the invention and according to one embodiment thereof, there is provided a receiving and display system including a receiving apparatus and a display terminal, the receiving apparatus receiving data from outside, the display terminal displaying information by receiving data from the receiving apparatus; wherein, upon receipt of an upgraded program from outside, the receiving apparatus checks to determine whether the upgraded program is destined for the receiving apparatus or for the display terminal, the receiving apparatus further writing the upgraded program to a storage device of the receiving apparatus if the upgraded program is found to be destined for the receiving apparatus, the receiving apparatus further transferring the upgraded program to the display terminal if the upgraded program is found to be destined for the display terminal; and wherein the display terminal writes the upgraded program transferred from the receiving apparatus to a storage device of the display terminal.

In the above-outlined receiving and display system, the display terminal has no ability to directly receive data from outside the system. Still, the receiving apparatus upon receiving an upgraded program from outside replaces its existing program with the received program if the program is destined for the apparatus, and transfers the program to the display terminal if the program is destined for the terminal so that the terminal may replace its existing program with the upgraded program transferred.

With the inventive receiving and display system implemented as outlined above, the component receiving apparatus and display terminal may replace their existing programs with the upgraded program sent from outside. In this setup, there is no need to furnish the display terminal with capabilities to directly receive data from outside the system.

### BRIEF DESCRIPTION OF THE DRAWINGS

FIG. 1 is a block diagram outlining a receiving and display system including a receiving apparatus and a display terminal according to the present invention;

FIGS. 2A and 2B are schematic views explanatory of ROMs used by the receiving apparatus and display terminal;

FIG. 3 is a flowchart of steps constituting a data broadcast reception process performed by the CPU of the receiving apparatus; and

FIG. 4 is a flowchart of steps constituting a reception process performed by the CPU of the display terminal.

### DETAILED DESCRIPTION OF THE PREFERRED EMBODIMENTS

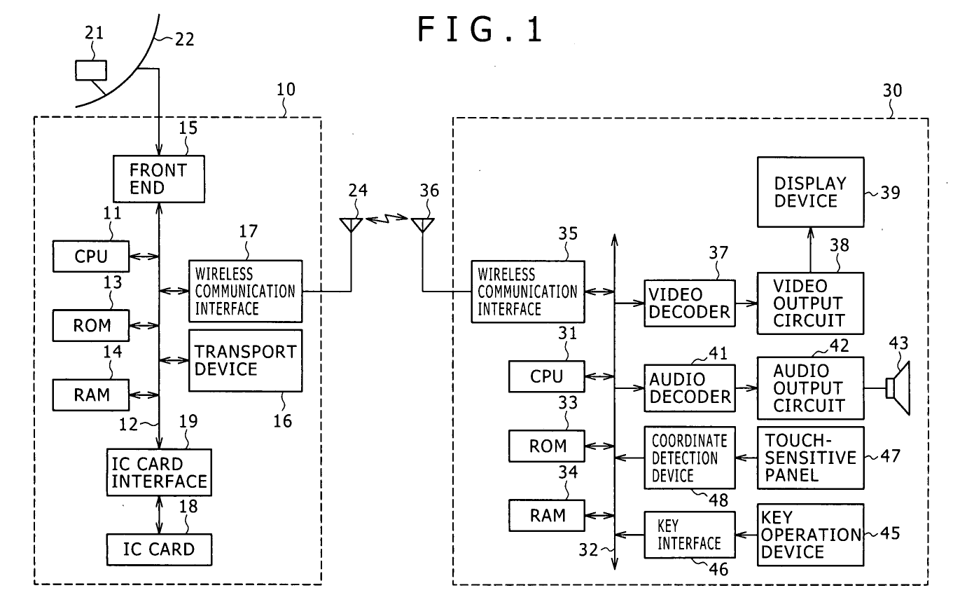

### 1. System Configuration (FIG. 1)

FIG. 1 shows a typical receiving and display system that embodies the present invention. This receiving and display system is structured as a wireless TV system made up of a receiving apparatus 10 and a display terminal 30 with a wireless LAN established therebetween.

The broadcasting side, not shown, has a server that encodes an upgraded program illustratively as conditional access data forming part of the data broadcast in CS or BS digital broadcasts. The upgraded program thus encoded is broadcast in a plurality of packets including a decoder ID. The upgraded program is destined either for the receiving apparatus or for the display terminal. The program destination is determined by information added to a header part of the data making up the program.

With this embodiment, the receiving apparatus 10 is structured as a digital TV receiver that receives CS and BS digital broadcasts. More specifically, the receiving apparatus 10 has a CPU 11 and a bus 12 connected to it. The bus 12 is connected to a ROM 13, a RAM 14, a front end 15, a transport device 16, and a wireless communication interface 17. The front end 15 is connected to an antenna 22 equipped with a converter 21. The wireless communication interface 17 is connected to another antenna 24. An IC card 18 is connected to the bus 12 through an IC card interface 19.

The radio waves of CS or BS digital broadcasts are received by the antenna 22. The received radio waves are down-converted by the converter 21 before being output as a signal to the front end 15.

The signal coming from the converter 21 is demodulated by the front end 15. The demodulated signal is further subjected to error correction by the front end 15 before being output to the transport device 16 as data in packets.

The transport device 16 separates the data packets coming from the front end 15 into two categories: video and audio data packets, and conditional access data packets. As mentioned above, the upgraded program is included in the conditional access data.

The conditional access data is sent to the IC card 18 through the IC card interface 19. The CPU in the IC card 18 checks to determine whether this receiving apparatus 10 has the right to access the conditional access data in question.

More specifically, the CPU in the IC card 18 requests the CPU 11 to furnish the decoder ID assigned to this receiving apparatus 10. In response, the CPU 11 reads the decoder ID from the ROM 13 and forwards the retrieved ID to the IC card 18. The CPU in the IC card 18 checks to determine whether the decoder ID grants the right to access the conditional access data in question.

If the receiving apparatus 10 is found to have the right to access the conditional access data, then the IC card 18 outputs a decryption key (i.e., control word) to the transport device 16 through the IC card interface 19. In turn, the transport device 16 decrypts the conditional access data using the key (control word).

The data in video and audio packets separated by the transport device 16 is transmitted from the antenna 24 to the display terminal 30 as a wireless frequency signal through the wireless communication interface 17. As will be discussed later, the upgraded program destined for the display terminal 30 in the form of conditional access data is also transmitted from the antenna 24 to the display terminal 30 as a wireless frequency signal through the wireless communication interface 17.

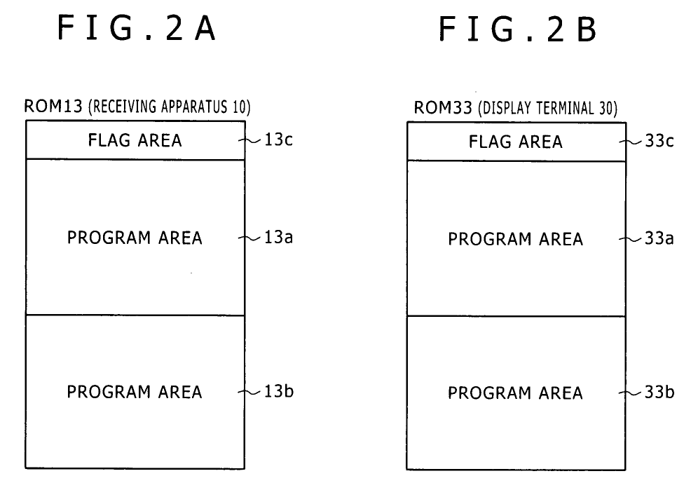

The ROM 13 is a nonvolatile rewritable memory. As shown in FIG. 2A, the ROM 13 has its storage space divided into program areas 13a and 13b and a flag area 13c.

A different program is written to each of the program areas 13a and 13b. The CPU 11 carries out the program held in one of the program areas 13a and 13b. The other area is reserved as an area to which to write an upgraded program. The flag area 13c is set with an identification flag indicating which of the programs in the program areas 13a and 13b is to be executed.

Illustratively, suppose that the program area 13a is currently used (i.e., that the program written in the program area 13a is being carried out). In this case, an upgraded program destined for the receiving apparatus 10 is written to the program area 13b by the CPU 11. When the upgraded program write is completed, the identification flag in the flag area 13c is rewritten in such a manner that the program area 13b will be used next time the receiving apparatus 10 is started (i.e., the program written in the program area 13b will be carried out next time).

As shown in FIG. 1, the display terminal 30 has a CPU 31 and a bus 32 connected to it. The bus 32 is connected to a ROM 33, a RAM 34, and a wireless communication interface 35. An antenna 36 is connected to the wireless communication interface 35.

A display device 39 such as a liquid crystal display is connected to the bus 32 through a video decoder 37 and a video output circuit 38. Speakers 43 are also connected to the bus 32 via an audio decoder 41 and an audio output circuit 42.

A key operation device 45 is connected to the bus 32 through a key interface 46. A touch-sensitive panel 47 furnished on the display screen of the display device 39 is connected to the bus 32 via a coordinate detection device 48.

Data in video and audio packets and an upgraded program destined for the display terminal 30 are transmitted from the antenna 24 of the receiving apparatus 10. The transmitted data and program are received by the antenna 36 of the display terminal 30 and output onto the bus 32 through the wireless communication interface 35.

The video data and audio data placed onto the bus 32 are decoded by the video decoder 37 and audio decoder 41 respectively. The upgraded program destined for the display terminal 30 is written to the ROM 33 by the CPU 31.

As with the ROM 13 of the receiving apparatus 10, the ROM 33 is a nonvolatile rewritable memory. As shown in FIG. 2B, the ROM 33 has its storage space divided into program areas 33a and 33b and a flag area 33c.

A different program is written to each of the program areas 33a and 33b. The CPU 31 carries out the program held in one of the program areas 33a and 33b. The other area is reserved as an area to which to write an upgraded program. The flag area 33c is set with an identification flag indicating which of the programs in the program areas 33a and 33b is to be executed.

Illustratively, suppose now that the program area 33a is currently used (i.e., that the program written in the program area 33a is being carried out). In this case, an upgraded program destined for the display terminal 30 is written to the program area 33b by the CPU 31. When the upgraded program write is completed, the identification flag in the flag area 33c is rewritten in such a manner that the program area 33b will be used next time the display terminal 30 is started (i.e., the program written in the program area 33b will be carried out next time).

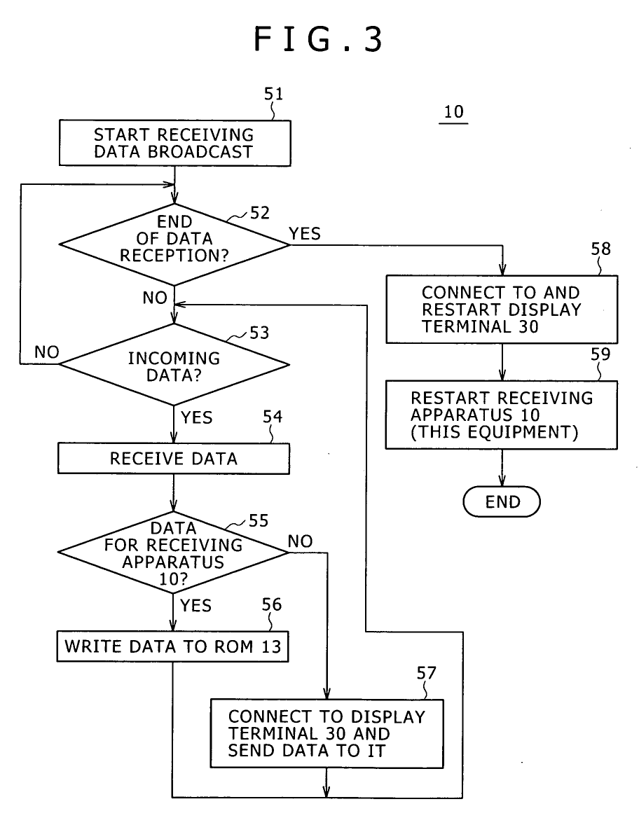

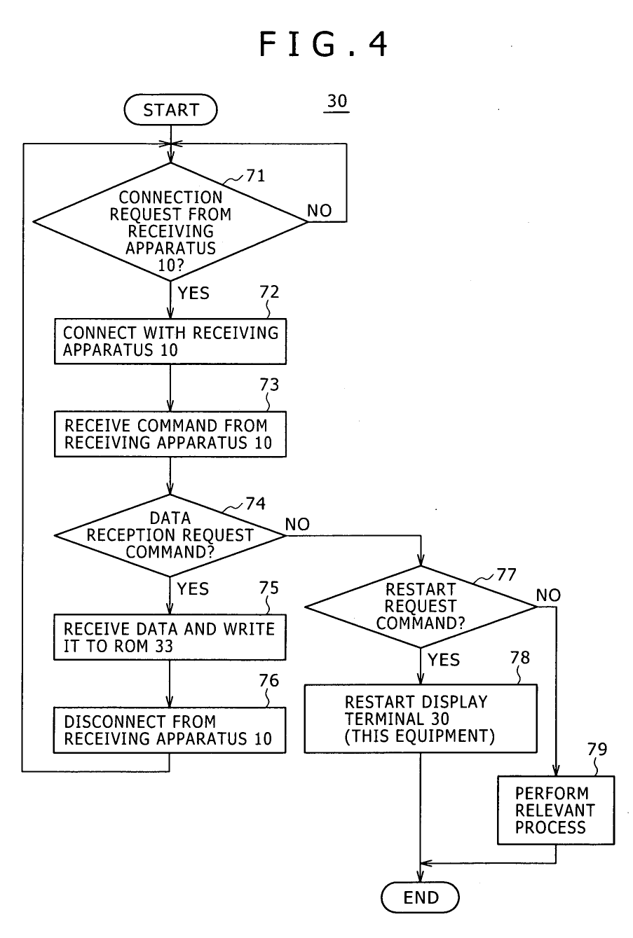

### 2. How to Upgrade (FIGS. 3 and 4)

The CPU 11 of the receiving apparatus 10 checks the above-mentioned header information in an upgraded program constituted by conditional access data, to determine whether the upgraded program is destined for the receiving apparatus 10 (this equipment) or for the display terminal 30. If the upgraded program is found to be destined for the receiving apparatus 10, the program is decrypted according to the AES (Advanced Encryption Standard) before being written to the ROM 13 and subjected to data checks using illustratively MD5 (Message Digest Algorithm 5).

If the upgraded program is found to be destined for the display terminal 30, the CPU 11 of the receiving apparatus 10 connects to the display terminal 30 illustratively according to the FTP (File Transfer Protocol). With the connection established, the CPU 11 transfers the upgraded program to the display terminal 30.

The CPU 31 of the display terminal 30 receives the upgraded program destined for this equipment (i.e., display terminal 30) transferred from the receiving apparatus 10, and decrypts the received program illustratively according to the AES. The decrypted program is written to the ROM 33 and subjected to data checks using illustratively MD5.

FIG. 3 is a flowchart of steps constituting the data broadcast reception process typically performed as outlined above by the CPU 11 of the receiving apparatus 10. In step 51, the reception of a data broadcast is started. In step 52, a check is made to determine whether the data reception has ended. More specifically, the CPU 11 checks to see if a data reception end packet is received. If the data reception is not found to have ended yet, control is passed from step 52 to step 53. In step 53, the CPU 11 checks to determine whether there is incoming data. If no incoming data is found, control is returned from step 53 to step 52. If any incoming data is detected, control is passed from step 53 to step 54. In step 54, the incoming data is received and placed temporarily into the RAM 14.

In step 55, the CPU 11 of the receiving apparatus 10 checks the header information in the received data to determine whether the received data constitutes an upgraded program destined for the receiving apparatus 10 (i.e., this equipment) or for the display terminal 30.

If the received data is found to be the upgraded program destined for the receiving apparatus 10 (this equipment), control is passed from step 55 to step 56. In step 56, the apparatus-destined upgraded program is decrypted and written to the currently unused program area in the ROM 13 (e.g., to the program area 13b). Control is then returned from step 56 to step 53.

If the received data is found to be the upgraded program destined for the display terminal 30, then control is passed from step 55 to step 57. In step 57, the CPU 11 connects to the display terminal 30 illustratively according to the FTP. With the connection established, the terminal-destined upgraded program is transferred to the display terminal 30. Following the program transfer and the disconnection from the display terminal 30, control is returned from step 57 to step 53.

If in step 52 the data reception is found to have ended, step 58 is reached. In step 58, the CPU 11 connects to the display terminal 30 illustratively as per the FTP and restarts the terminal using typically an extended FTP command. Thereafter, step 59 is reached and the CPU 11 restarts the receiving apparatus 10 (i.e., this equipment).

When rebooted, the receiving apparatus 10 and the display terminal 30 restart using their upgraded programs as described above.

FIG. 4 is a flowchart of steps constituting the data reception process typically performed as outlined above by the CPU 31 of the display terminal 30. When the display terminal 30 is switched on, the CPU 31 goes to step 71 and checks to determine whether there is a connection request from the receiving apparatus 10. If the connection request from the receiving apparatus 10 is detected, step 72 is reached. In step 72, the CPU 31 connects with the receiving apparatus 10 illustratively according to the FTP. In step 73, the CPU 31 receives a command from the receiving apparatus 10. In step 74, the CPU 31 checks to determine whether the received command is a data reception request command.

If the received command is found to be the data reception request command, control is passed from step 74 to step 75. In step 75, the CPU 31 receives the data constituting the upgraded data destined for the display terminal 30 (i.e., this equipment), decrypts the received program, and writes the decrypted program illustratively to the program area 33b. In step 76, the CPU 31 disconnects from the receiving apparatus 10 and returns to step 71.

If in step 74 the received command is found to be something other than the data reception request command, control is passed from step 74 to step 77. In step 77, the CPU 31 checks to determine whether the received command is a restart request command. If the received command is found to be the restart request command, then control is passed from step 77 to step 78. Since the upgraded program has already been received, the CPU 31 restarts the display terminal 30 (this equipment) in step 78 and executes the newly upgraded program.

If in step 77 the received command is found to be something other than the restart request command, control is passed from step 77 to step 79. In step 79, the CPU 31 carries out the process relevant to the received command.

### 3. Other Embodiments or Examples

With the above-described embodiment, an upgraded program is transmitted as a data broadcast constituting part of CS or BS digital broadcasts. The transmitted program is received by the receiving apparatus 10 for subsequent upgrades. Alternatively, a similar and equally effective scheme can be implemented with terrestrial digital broadcasting arrangements. An upgraded program may be transmitted as a data broadcast constituting part of terrestrial digital broadcasts and may be received by the receiving apparatus for subsequent upgrades.

The present invention can be applied not only to TV broadcasts but also to cable TV setups and communication networks such as the Internet whereby data is received by the receiving apparatus and information is displayed by the display terminal.

The receiving apparatus and display terminal as components making up the receiving and display system may be interconnected not only wirelessly as discussed above, but also in wired fashion.

It should be understood by those skilled in the art that various modifications, combinations, sub-combinations and alterations may occur depending on design requirements and other factor in so far as they are within the scope of the appended claims or the equivalents thereof.

What is claimed is:

1. A receiving and display system comprising:
a receiving apparatus; and
a display terminal;
wherein, said receiving apparatus receiving data from outside and said display terminal displaying information by receiving data from said receiving apparatus;
wherein, upon receipt of an upgraded program from outside, said receiving apparatus checks to determine whether said upgraded program is destined for said receiving apparatus or for said display terminal, said receiving apparatus further writing said upgraded program to a storage device of said receiving apparatus if said upgraded program is found to be destined for said receiving apparatus, said receiving apparatus further transferring said upgraded program to said display terminal if said upgraded program is found to be destined for said display terminal; and
wherein said display terminal writes said upgraded program transferred from said receiving apparatus to a storage device of said display terminal.

2. The receiving and display system according to claim 1, wherein said receiving apparatus writes said upgraded program to a program area separate from another program area currently used in the storage device of said receiving apparatus; and
wherein said display terminal writes said upgraded program to a program area separate from another program area currently used in the storage device of said display terminal.

3. The receiving and display system according to claim 1, wherein said receiving apparatus is capable of receiving digital broadcasts.

4. A receiving apparatus which is connected in either wired or wireless fashion to a display terminal and which receives data from outside;
wherein, upon receipt of an upgraded program from outside, said receiving apparatus checks to determine whether said upgraded program is destined for said receiving apparatus or for said display terminal, said receiving apparatus further writing said upgraded program to a storage device of said receiving apparatus if said upgraded program is found to be destined for said receiving apparatus, said receiving apparatus further transferring said upgraded program to said display terminal if said upgraded program is found to be destined for said display terminal.

5. The receiving apparatus according to claim 4, wherein said upgraded program is written to a program area separate from another program area currently used in the storage device of said receiving apparatus.

6. The receiving apparatus according to claim 4, wherein said receiving apparatus is capable of receiving digital broadcasts.

7. A display terminal which is connected in either wired or wireless fashion to a receiving apparatus receiving data from outside and which displays information upon receiving data from said receiving apparatus;
wherein an upgraded program received by said receiving apparatus from outside and transferred from said receiving apparatus is written to a program area separate from another program area currently used in a storage device of said display terminal.
